(19) United States
(12) Patent Application Publication
(10) Pub. No.: US 2008/0233929 A1
(43) Pub. Date: Sep. 25, 2008

(54) Information processing device for notifying a requested address information to another information processing devices

(75) Inventors: Katsuaki Akama, Kawasaki (JP); Narumasa Suzuki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/076,433

(22) Filed: Mar. 18, 2008

(30) Foreign Application Priority Data
Mar. 19, 2007 (JP) 2007-071388

(51) Int. Cl. H04Q 7/38

(52) U.S. Cl. 455/414.2

(57) ABSTRACT

According to an aspect of an embodiment, an information processing device for communicating with another information processing devices, the information processing device comprises: a storage unit for storing a table containing address information which is either permitted or not permitted to notify the another information processing devices; a processor for performing a process of communicating with the another information processing devices comprising the steps of: determining whether address information requested from the another information processing device is rated as permitted in the table; and notifying the requested address information to the another information processing device when the requested address information is rated as permitted in the table.

### BACKGROUND OF THE INVENTION

1. Field of the Invention

This art relates to a cellular phone having a telephone directory function.

2. Description of the Related Art

An information processing device such as a cellular phone generally cannot transmit a mail without knowing the mail address of the other party. Accordingly, it is necessary for the user of a cellular phone or the like to preliminarily obtain the mail address of the other party.

When attempt to transmit a mail to other person whose mail address is unknown, it is necessary to hear the address by directly calling to the other person, or to hear the address from a common friend.

However, when disclosing the address of other person to a third person, it was bothersome to obtain anew permission from the other person. Further, in some cases, there is a problem in that the address is disclosed to a third person without confirming the permission.

Further, Japanese Laid-open Patent Publication No. 2002-320259 discloses an address disclosure system of an information processing device.

### SUMMARY

According to an aspect of an embodiment, an information processing device for communicating with another information processing devices, the information processing device comprises: a storage unit for storing a table containing address information which is either permitted or not permitted to notify the another information processing devices; a processor for performing a process of communicating with the another information processing devices comprising the steps of: determining whether address information requested from the another information processing device is rated as permitted in the table; and notifying the requested address information to the another information processing device when the requested address information is rated as permitted in the table.

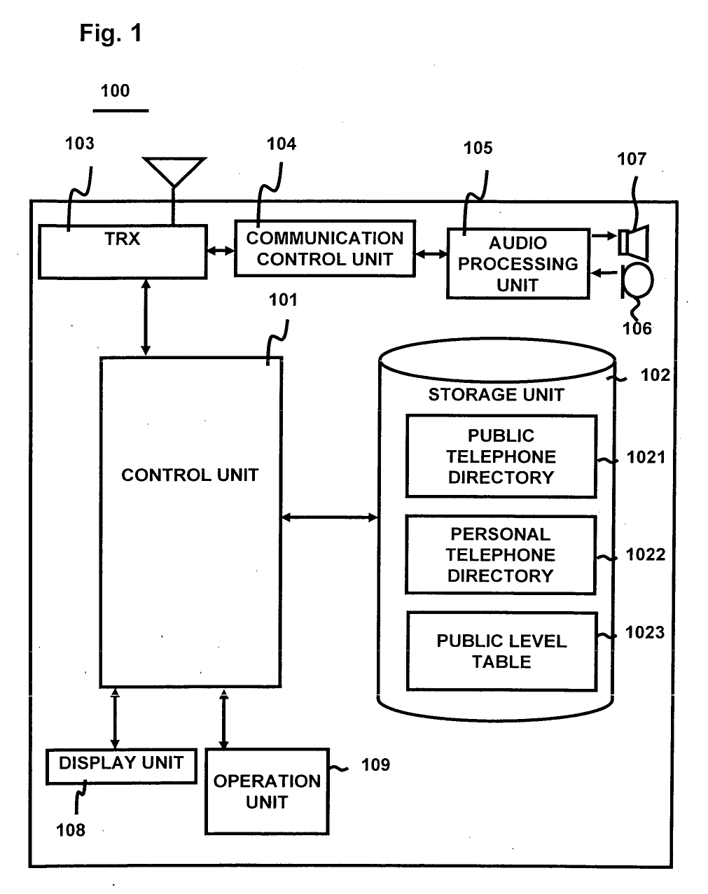

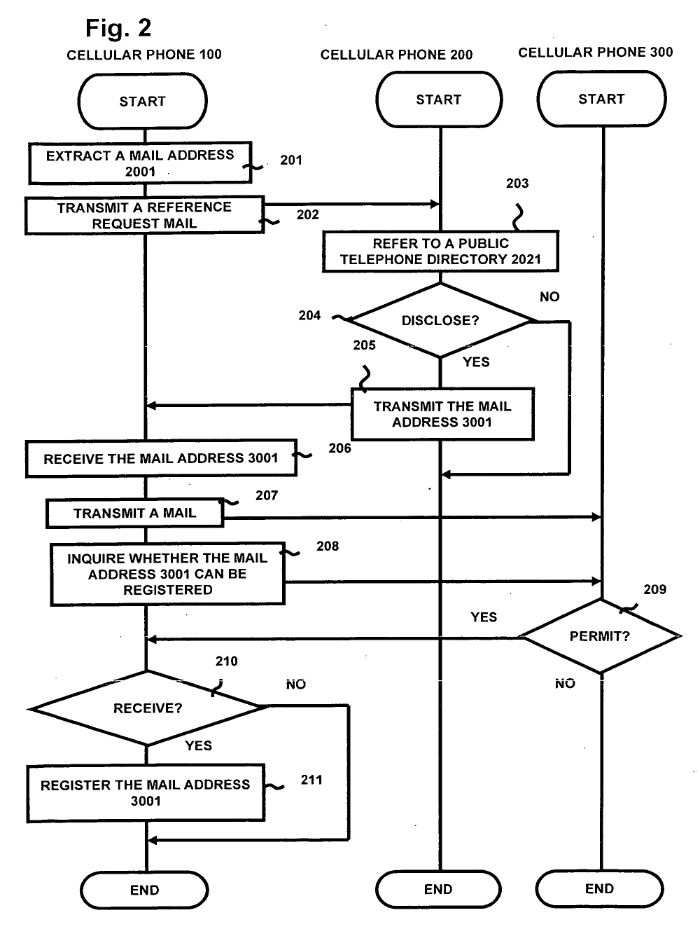

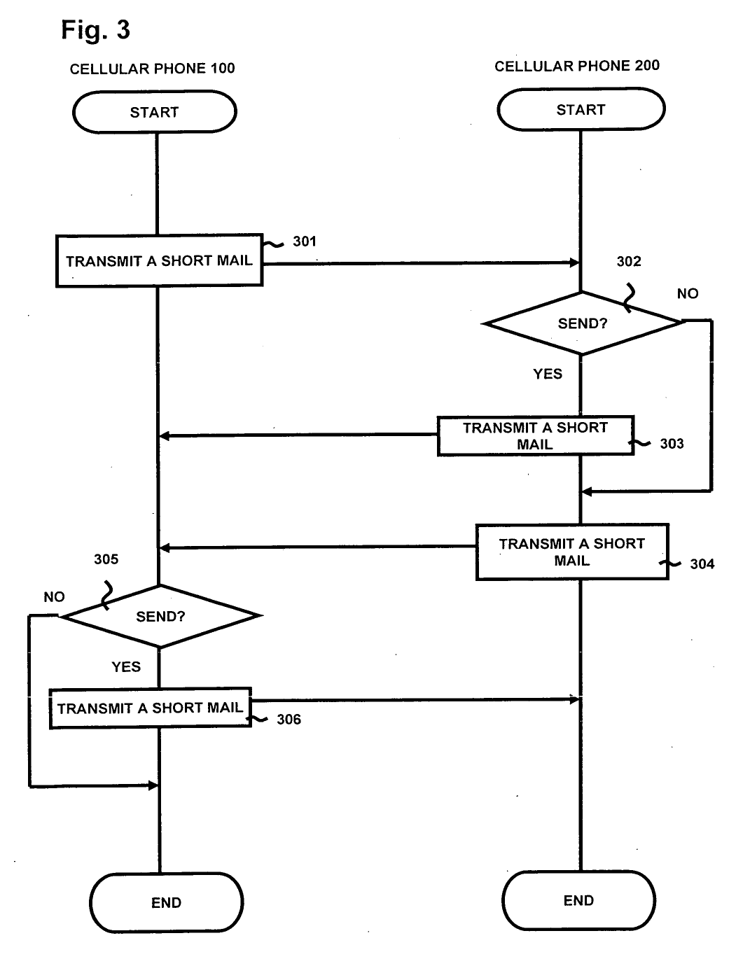

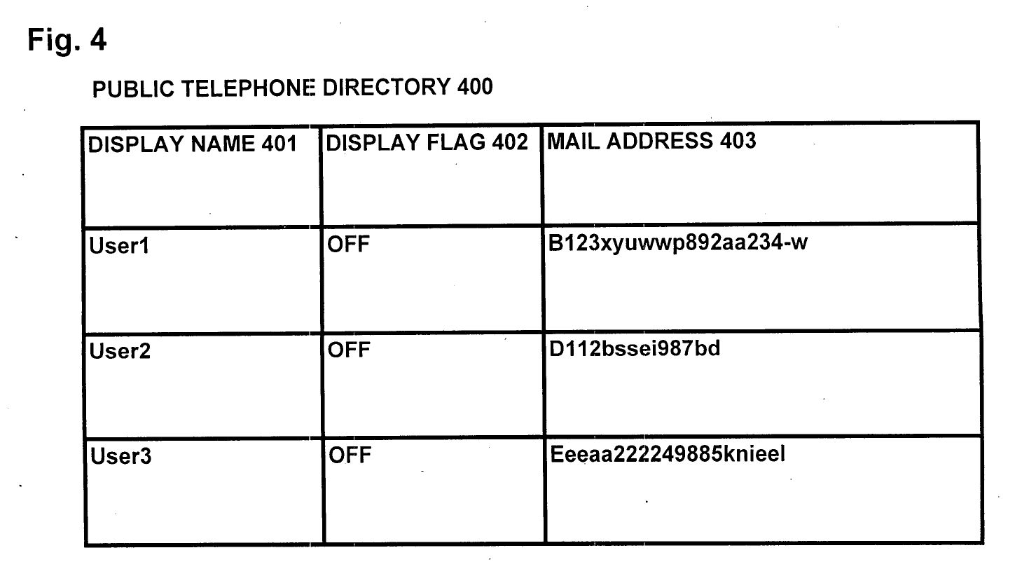

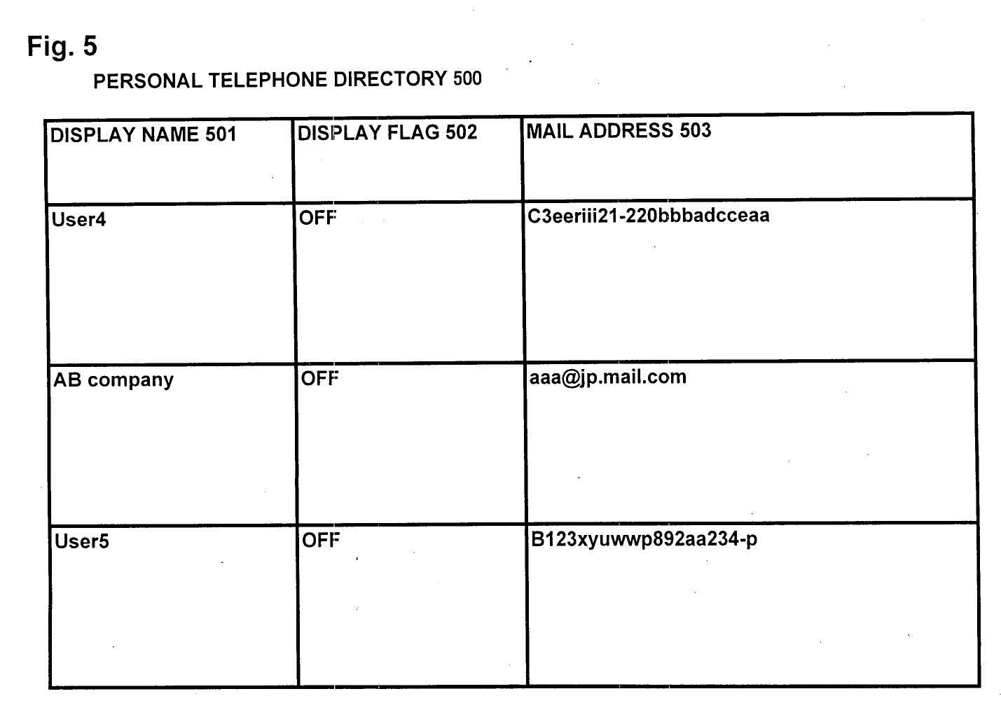

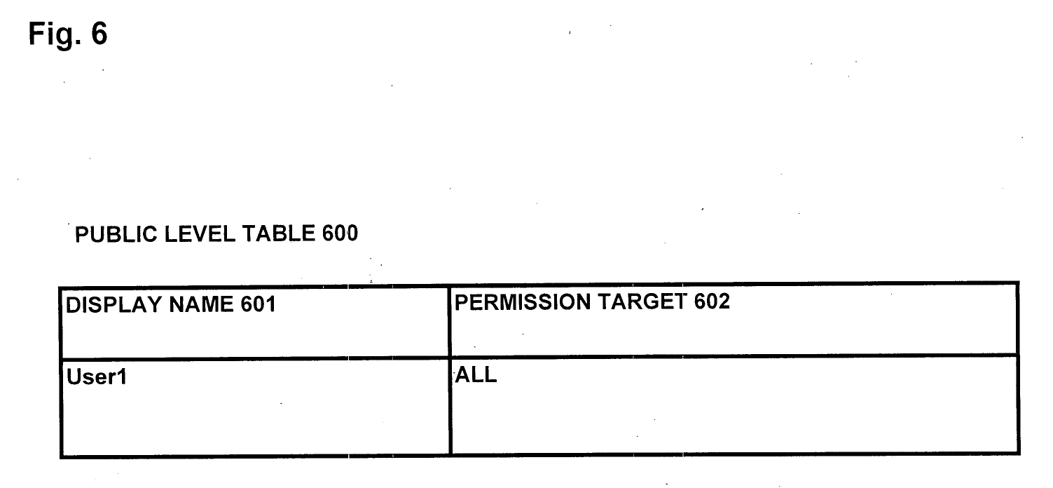

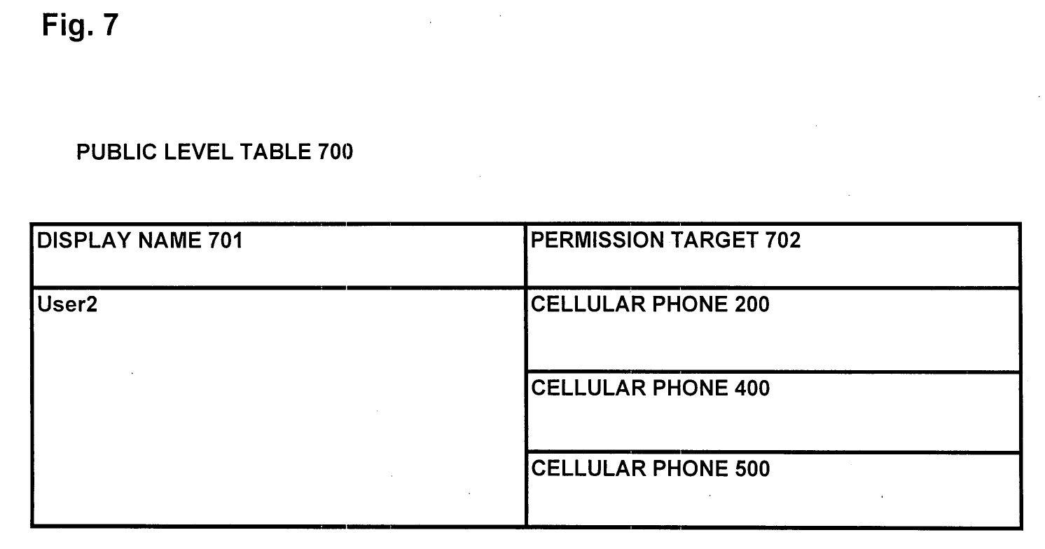

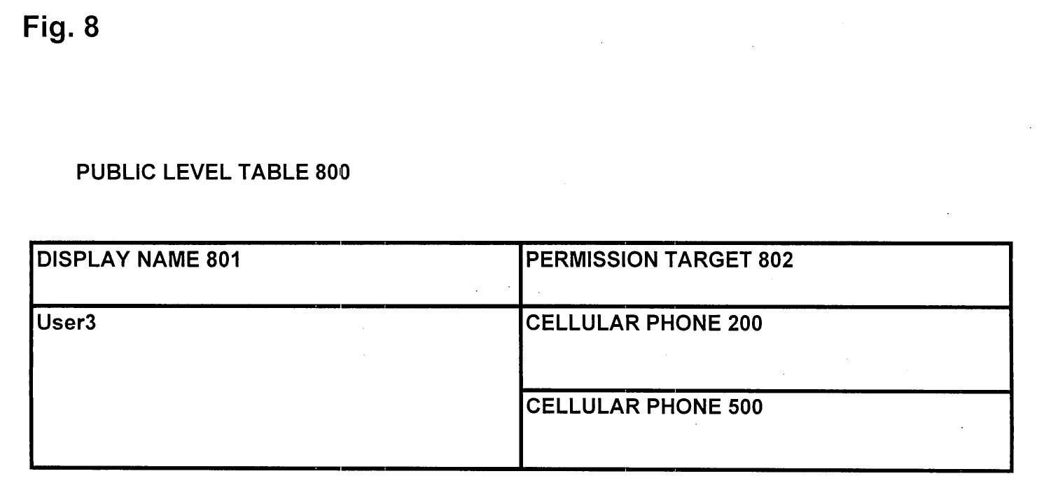

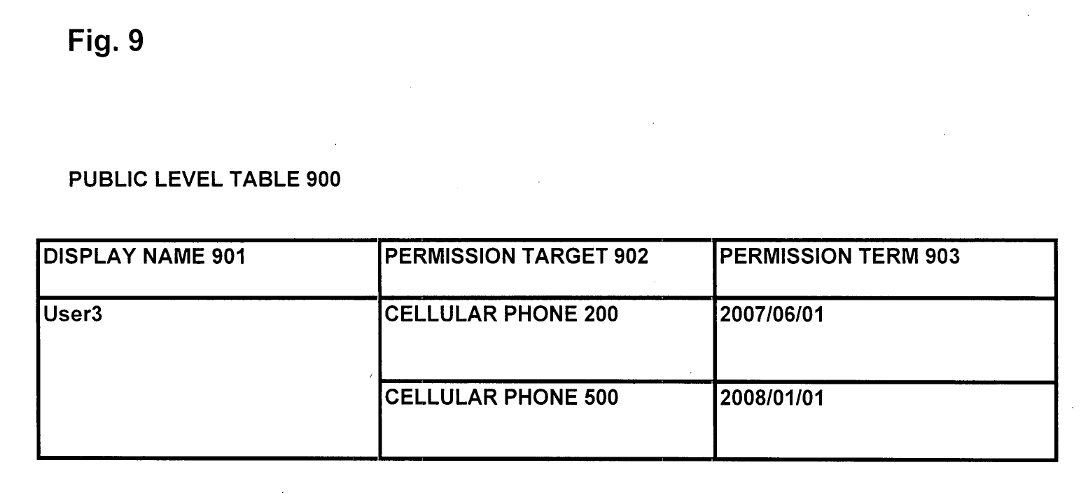

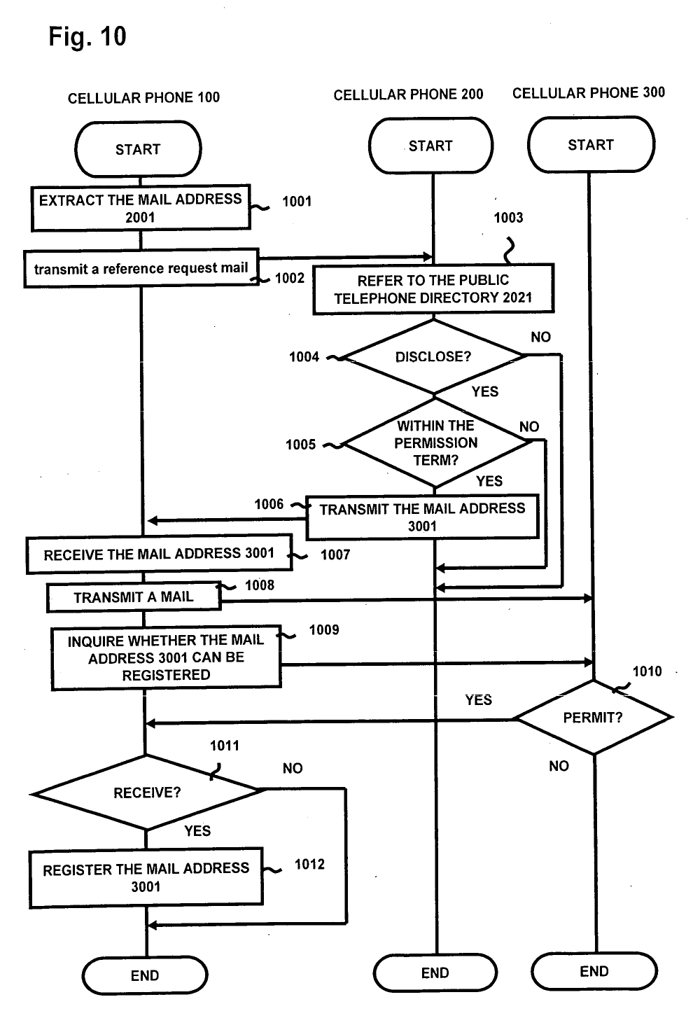

### BRIEF DESCRIPTION OF THE DRAWINGS

[FIG. 1] This is a hardware block diagram of a cellular phone according to the embodiment.

[FIG. 2] This is a sequence of registration process of a mail address according to the embodiment.

[FIG. 3] This is a sequence of disclosure process of a mail address according to the embodiment.

[FIG. 4] This is a public telephone director according to the embodiment.

[FIG. 5] This is a personal telephone directory according to the embodiment.

[FIG. 6] This is a public level table according to the embodiment.

[FIG. 7] This is a public level table according to the embodiment.

[FIG. 8] This is a public level table according to the embodiment.

[FIG. 9] This is a public level table according to the embodiment.

[FIG. 10] This is a sequence of registration process of a mail address according to the embodiment.

### DESCRIPTION OF THE PREFERRED EMBODIMENTS

FIG. 1 is a hardware block diagram of a cellular phone 100 according to the embodiment. The cellular phone 100 is exemplified as a device for performing communications. However, the device is not limited to the cellular phone 100 and may be an information processing device capable of communications such as a PC (Personal Computer), a PDA (Personal Digital Assistance), or the like.

The cellular phone 100 includes a control unit 101, a storage unit 102, a transmitting/receiving unit 103, a communication control unit 104, an audio processing unit 105, a microphone 106, a speaker 107, a display unit 108, and an operation unit 109.

The control unit 101 is constituted by a computer equipped with a CPU (Central Processing Unit), a ROM (Read Only Memory), a RAM (Random Access Memory), and the like and performs various control of the storage unit 102, the transmitting/receiving unit 103, the display unit 108, and the operation unit 109. These controls are processed by performing a control program stored in the ROM equipped in the control unit 101. The place in which the control program is stored is not limited to the ROM and may be another recording medium corresponding to the ROM.

The storage unit 102 is the generic name of a RAM, a ROM, and the like and may be constituted by a recording medium which can be attached and detached or may be constituted by an memory, for example, a flush memory or the like which does not lose recorded content even when power source is turned off. A public telephone directory 1021 and a personal telephone directory 1022 are stored in the storage unit 102.

A plurality of mail addresses which can be disclosed to a third person is stored in the public telephone directory 1021. A plurality of mail addresses which can not be disclosed to a third person is stored in the personal telephone directory 1022. A public level table 1023 is a table showing a target of disclosure of the corresponding mail address.

The transmitting/receiving unit 103 performs transmitting and/or receiving of a radio signal wave via an antenna.

The communication control unit 104, for example, modulates and demodulates a carrier signal with a signal representing an image, a call signal, a dial signal, and the like, and generates a radio signal wave for transmitting and receiving.

The audio processing unit 105 is connected to the microphone 106, the speaker 107, and converts an analog voice signal picked up from the speaker 107 to a digital signal and converts a digital voice signal output form the control unit 101 to an analog signal. The speaker 107 is used for outputting a voice signal output from the control unit 101 and a voice signal picked up via the microphone 106.

The display unit 108 is constituted by an LCD (Liquid Crystal Display) element and the like and displays various input information and output information to the control unit 101.

Ten keys, a call key, a call end key, a function key, a cross-shape key, and the like are provided in the operation unit 109 and the user can perform call operation and transmission and reception of a mail by using the operation unit 109. Further, the user can perform updating, editing, and the like of the public telephone directory 1021 and the personal telephone directory 1022 by operating the operation unit 109.

FIG. 2 is a sequence of registration process of a mail address according to the embodiment.

In the embodiment, the case will be described in which the cellular phone 100 obtains a mail address 3001 of a cellular phone 300 from a cellular phone 200.

The control unit 101 of the cellular phone 100 extracts a mail address 2001 of the cellular phone 200 from the public telephone directory 1021 (step S201). The control unit 101 transmits a reference request mail for requesting reference of a mail address of the cellular phone 300 to the cellular phone 200 via the transmitting/receiving unit 103 based on the extracted mail address 2001 (step S202).

The cellular phone 200 refers to a public telephone directory 2021 held by the cellular phone 200 when the reference request mail is received from the cellular phone 100 (step S203). Then, the mail address 3001 of the cellular phone 300 is registered in the public telephone directory 2021. The cellular phone 200 refers to a public level table 2023 corresponding to the mail address 3001 and judges whether the mail address 3001 can be disclosed to the cellular phone 100 or not (step S204). The cellular phone 200 can disclose the mail address 3001 of the cellular phone 300 to the cellular phone registered in the public level table 2023.

When the cellular phone 100 is registered in the public level table 2023 (step S204 YES), the cellular phone 200 extracts the mail address 3001 from the public telephone directory 2021 and transmits the mail address 3001 to the cellular phone 100 (step 205). When the cellular phone 100 is not registered in the public level table 2023 (step S204 NO), the cellular phone 200 does not transmit the mail address 3001 to the cellular phone 100.

When the cellular phone 100 receives the mail address 3001 via the transmitting/receiving unit 103 (step S206), the control unit 101 transmits a mail to the cellular phone 300 by using the mail address received from the cellular phone 200 via the transmitting/receiving unit 103 (step S207). In step S207, the mail transmitted from the cellular phone 100 to the cellular phone 300 is a mail to notice that the mail address 3001 is obtained by the cellular phone 100 from the cellular phone 200. Then, the cellular phone 100 inquires whether or not the mail address 3001 can be registered in the public telephone directory 1021 held by the cellular phone 100 (step S208).

The cellular phone 300 judges whether the registration of the mail address 3001 in the public telephone directory 1021 is permitted or not (step S209). When the cellular phone 300 judges that the registration of the mail address 3001 in the public telephone directory 1021 is permitted (step S209 YES), the cellular phone 300 transmits a permission answer for permitting the registration to the cellular phone 100. When the cellular phone 300 judges that registration of the mail address 3001 of the cellular phone 300 in the public telephone directory 1021 is not permitted (step S209 NO), the cellular phone 300 does not transmit a permission answer for permitting the registration to the cellular phone 100, and process is finished.

The cellular phone 100 judges whether the permission answer for permitting the registration of the mail address 3001 in the public telephone directory 1021 is received or not from the cellular phone 300 (step S210). When judged that the permission answer is received (step S210 YES), the cellular phone 100 registers the mail address 3001 of the cellular phone 300 in the public telephone directory 1021 (step S211). When judged the permission answer is not received (step S210 NO), the cellular phone 100 does not register the mail address 3001 in the public telephone directory 1021, and finishes the process.

In step S205 in the embodiment, the mail address 3001 is extracted from the public telephone directory 2021 and transmitted to the cellular phone 100. However, the cellular phone 200 may transmit the public telephone directory 2021 to the cellular phone 100.

FIG. 3 is a sequence of the registration of a mail address according to the embodiment.

In the embodiment, an example will be described in the case where the user of the cellular phone 100 and the user of the cellular phone 200 know each other's telephone number.

The cellular phone 100 tries to obtain the mail address 2001 to the cellular phone 200. By using a SMS function (Short Message Service), the cellular phone 100 specifies the telephone number of the cellular phone 200 as a destination mail address and transmit a short mail to the cellular phone 200 (step S301). The cellular phone 100 asks for obtaining of the mail address of the cellular phone 200 by the short mail.

When the short mail is received from the cellular phone 100, the cellular phone 200 judges whether the mail address 2001 held by the cellular phone 200 is transmitted to the cellular phone 100 or not (step S302). When the mail address 2001 is transmitted to the cellular phone 100 (step S302 YES), the cellular phone 200 specifies the telephone number of the cellular phone 100 as a destination mail address and transmits a short mail to the cellular phone 100 by using the SMS function (step S303). Herein, the mail address 2001 of the cellular phone 200 is included in the short mail transmitted to the cellular phone 100 from the cellular phone 200.

Subsequently, the cellular phone 200 tries obtaining of the mail address 1001 of the cellular phone 100 to the cellular phone 100. The cellular phone 200 specifies the telephone number of the cellular phone 100 as a destination mail address and transmits a short mail to the cellular phone 100 by the SMS function (step S304). Also when the cellular phone 200 does not transmit the mail address 2001 to the cellular phone 100 (step S302 NO), the cellular phone 200 specifies the telephone number of the cellular phone 100 as a destination mail address and transmits a short mail to the cellular phone 100 (step S304).

When the short mail is received from the cellular phone 200, the cellular phone 100 judges whether the mail address 1001 is transmitted to the cellular phone 200 or not (step S305). When the mail address 1001 is transmitted to the cellular phone 200 (step S305 YES), the cellular phone 100 specifies the telephone number of the cellular phone 200 as a destination mail address and transmits a short mail to the cellular phone 200 by using the SMS function (S306). Herein, the mail address 1001 of the cellular phone 100 is included in the short mail transmitted to the cellular phone 200 from the cellular phone 100. When judged that the mail address 1001 is not transmitted to the cellular phone 200 (step S305 NO), the cellular phone 100 does not transmit a short mail containing the mail address 1001 to the cellular phone 200.

FIG. 4 is a public telephone directory 400 according to the embodiment.

The public telephone directory 400 is information held by the cellular phone 100 and is a concrete example of the public telephone directory 1021 stored in the storage unit 102.

A mail address 403 which can be disclosed to a third person is stored in the public telephone directory 400. “Which can be disclosed” means that there exists a cellular phone whose mail address becomes a permission target of disclosure.

The public telephone directory 400 is constituted by display name 401, display flag 402, and mail address 403. “User 1” “User 2”, and “User 3” described in the display name 401 are information indicating the user of each mail address registered in the public telephone directory 400 and displayed on the display unit 108 of the cellular phone 100. The user of the cellular phone 100 can select a desired mail address 403 for transmitting a mail by referring the display name 401 displayed on the display unit 108.

The display flag 402 is a flag that indicates whether or not the mail address 403 is displayed on the display unit 108. The mail address 403 whose display flag 402 is OFF is not displayed on the display unit 108. Accordingly, the user of the cellular phone 100 can not recognize the mail address 403. Herewith, it can be prevented that the user of the cellular phone 100 leaks the mail address recorded in the cellular phone 100 to a third person.

The mail address 403 is a mail address corresponding to the user shown in the display name 401. “B123xyuwwp892aa234-w” corresponds to “User 1”, “D112bssei987bd” corresponds to “User 2”, and “Eeeaa222249885knieel” corresponds to “User 3”. All of the mail addresses 403 “B123xyuwwp892aa234-w”, “D112bssei987bd”, and “Eeeaa222249885knieel” are not displayed on the display unit 108. This is because the display flags 402 corresponding to all of the mail addresses 403 are set OFF.

FIG. 5 is a personal telephone directory 500 according to the embodiment.

The personal telephone directory 500 is to store information held by the cellular phone 100 and a concrete example of the personal telephone directory 1022 stored in the storage unit 102.

Information which can not be transmitted to another cellular phone from the cellular phone 100 is stored in the personal telephone directory 500. Disclosure of the mail address 503 registered in the personal telephone directory 500 to a third person is prohibited.

The personal telephone directory 500 is constituted by items such as display name 501, display flag 502, mail address 503. “User 4”, “AB Company”, and “User 5” described in the display name 501 are displayed on the display unit 108 of the cellular phone 100. Then, the user of the cellular phone 100 can select a desired mail address 503 for transmitting a mail by referencing the display name 501 displayed on the display unit 108.

The display flag 502 is a flag that indicates whether or not the mail address 503 is displayed. The mail address “C3eeriii21-220bbbadcceaa” corresponding to “User 4” and “B123xyuwwp892aa234-p” corresponding to “User 5” whose display flags 502 are OFF are not displayed on the display unit 108. Accordingly, the user of the cellular phone 100 can not recognize the mail addresses “C3eeriii21-220bbbadcceaa” and “B123xyuwwp892aa234-p”. Herewith, it is prevented that the user of the cellular phone 100 leaks the mail addresses “C3eeriii21-220bbbadcceaa” and “B123xyuwwp892aa234-p” to a third person. Further, the display flag 502 of the mail address “aaa@jp.mail.com” corresponding to “AB Company” is also “OFF”, so that the mail address is not displayed on the display unit 108.

FIG. 6 is a public level table 600 according to the embodiment.

Information about user and cellular phone which become permission target of disclosure of mail address is recorded in the public level table 600 for every mail address recorded in the public telephone directory. Further the public level table 600 is constituted from display name 601 and permission target 602.

The public level table 600 shown in FIG. 6 corresponds to the mail address “B123xyuwwp892aa234-w” of “User 1”. The permission target 602 of “B123xyuwwp892aa234-w” of “User 1” is “ALL”. “ALL” means that “B123xyuwwp892aa234-w” can be disclosed for all third persons and means that there is no restriction in disclosure target.

Similarly, FIG. 7 is a public level table 700 according to the embodiment.

The public level table 700 is constituted from display name 701 and permission target 702. Then, the public level table 700 corresponds to the mail address “D112bssei987bd” of “User 2”. The permission targets 702 of the mail address “D112bssei987bd” of “User 2” are “cellular phone 200”, “cellular phone 400” and “cellular phone 500”. The mail address “D112bssei987bd” corresponding to “User 2” can be disclosed only to “cellular phone 200”, “cellular phone 400” and “cellular phone 500” based on the public level table 700.

Similarly, FIG. 8 is a public level table 800 according to the embodiment.

The public level table 800 is constituted from display name 801 and permission target 802. The public level table 800 corresponds to the mail address “Eeeaa222249885knieel” of “User 3”. The permission target 802 of the mail address “Eeeaa222249885knieel” of “User 3” is “cellular phone 200” and “cellular phone 500”. The mail address “Eeeaa222249885knieel” corresponding to “User 3” can be disclosed only to “cellular phone 200” and “cellular phone 500” based on the public level table 800. Further, the control unit 101 may modify the public level tables 600, 700, and 800 and can modify the permission targets 602, 702, and 802.

In addition, when no permission target exists in the public level table (the case of blank), there is no third person to which the corresponding mail address can be noticed. Accordingly, when the control unit 101 modifies the public level table and there exists no permission target, the public level table in which no permission target exists is eliminated from the storage unit 102. Then, the display name, the display flag, and the mail address in the public telephone directory and the display name, the display flag, and the mail address corresponding to the eliminated public level table are eliminated. Further, the control unit 101 registers the display name, the display flag, and the mail address eliminated from the public telephone directory in the personal telephone directory and updates the personal telephone directory.

Further, FIG. 9 is also a public level table 900 according to the embodiment.

The public level table 900 is a modification of the public level tables 600, 700, and 800 described in FIG. 6, FIG. 7, and FIG. 8 and is constituted from items such as display name 901, permission target 902, permission term 903, and the like.

The public level table 900 further includes the permission term 903 indicating a term to permit disclosing of the mail address “Eeeaa222249885knieel” of the “User 3” to the permission target 902. Herewith, the time period in which the mail address can be disclosed can be set for every permission target 902 and disclosure of the mail address can be further flexibly performed.

The mail address “Eeeaa222249885knieel” corresponding to “User 3” can be disclosed to only “cellular phone 200” and “cellular phone 500” based on the public level table 900. Then, the permission term 903 of “cellular phone 200” is “2007/06/01” and the permission term 903 of “cellular phone 500” is “2008/01/01”. Further, the control unit 101 may modify the public level tables 600, 700, 800, and 900 and can modify the permission targets 602, 702, 802 and 902 and the permission term 903.

FIG. 10 is a sequence of registration process of a mail address according to the embodiment.

The case where the cellular phone 100 obtains the mail address 3001 of the cellular phone 300 from the cellular phone 200 will be described.

The control unit 101 of the cellular phone 100 extracts the mail address 2001 of the cellular phone 200 from the public telephone directory 1021 (step S1001). The control unit 101 transmits a reference request mail to the cellular phone 200 via the transmitting/receiving unit 103 based on the extracted mail address 2001 (step S1002).

When the reference request mail is received from the cellular phone 100, the cellular phone 200 refers to the public telephone directory 2021 held by the cellular phone 200 (step S1003). Then, the mail address 3001 of the cellular phone 300 is registered in the public telephone directory 2021. The cellular phone 200 refers to the public level table 2023 corresponding to the mail address 3001 and judges whether the mail address 3001 can be disclosed to the cellular phone 100 or not (step S1004). The cellular phone 200 can disclose the mail address 3001 of the cellular phone 300 to the cellular phone registered in the public level table 2023.

When the cellular phone 100 is registered in the public level table 2023 (step S1004 YES), the cellular phone 200 refers to the permission term corresponding to the cellular phone 100 in the public level table 2023 and judges whether the present time of the cellular phone 200 is within the permission term or not (step S1005). Herein, the permission term indicates a period in which the mail address 3001 can be disclosed to the cellular phone 100. Further, in the embodiment, the present time of the cellular phone 200 is a time measured by a clock function included in the cellular phone 200.

When the present time of the cellular phone 200 is within the permission term (step S1005 YES), the cellular phone 200 extracts the mail address 3001 from the public telephone directory 2021 and transmits to the cellular phone 100 (step S1006). When the cellular phone 100 is not registered in the public level table 2023 (step S204 NO), the cellular phone 200 does not transmit the mail address 3001 to the cellular phone 100. Also when the present time of the cellular phone 200 is not within the permission term (step S1005 NO), the cellular phone 200 does not transmit the mail address 3001 to the cellular phone 100.

When the mail address 3001 is received via the transmitting/receiving unit 103 (step S1007), the control unit 101 of the cellular phone 100 transmits a mail to the cellular phone 300 via the transmitting/receiving unit 103 (step S1008). In step S1008, the mail transmitted to the cellular phone 300 from the cellular phone 100 is a mail to notice that the mail address 3001 is obtained by the cellular phone 100. Then the cellular phone 100 inquires whether the mail address 3001 may be registered in the public telephone directory 1021 held by the cellular phone 100 or not to the cellular phone 300 (step S1009).

The cellular phone 300 judges whether the registration of the mail address 3001 in the public telephone directory 1021 is permitted or not (step S1009). When judged that the registration of the mail address 3001 in the public telephone directory 1021 is permitted (step S1010 YES), the cellular phone 300 notices the cellular phone 100 about the permission response indicating that the registration is permitted. When the cellular phone 300 judges not to permit the registration of the mail address 3001 in the public telephone directory 1021 (step S1010 NO), the cellular phone 300 does not notice the cellular phone 100 about the permission response indicating that the registration is permitted and finishes the process.

The cellular phone 100 judges whether the permission response indicating that the registration of the mail address 3001 in the public telephone directory 1021 is permitted is received or not from the cellular phone 300 (step S1011). When judged that the permission response is received (step S1011 YES), the cellular phone 100 registers the mail address 3001 of the cellular phone 300 in the public telephone directory 1021 (step S1012). When judged that the permission response is not received (step S1011 NO), the cellular phone 100 does not register the mail address 3001 in the public telephone directory 1021 and finishes the process.

In S1006 in the embodiment, the mail address 3001 is extracted from the public telephone directory 2021 and transmitted to the cellular phone 100. However the cellular phone 200 may transmit the public telephone directory 2021 to the cellular phone 100.

In addition, the cellular phones 100, 200, and 300 according to the embodiment provide a ciphered communication based on standards represented by 3GPP (Third Generation Partnership Project). Consequently, in the embodiment, leakage of mail address during communication can be prevented while exchanging each other's mail address, and exchanging of mail address can be provided only between desired cellular phones.

In addition, the address disclosure method according to the embodiment is provided by a network communication used for transmission and reception of mail address. However, the address disclosure method is not restricted to this and the communication such as an infrared communication, Bluetooth, or the like may be used instead of the network communication.

Further, the process performed by receiving means and notifying means of the invention is included in the process performed by the transmitting/receiving unit 103 of the embodiment. Further, the process performed by judging means of the invention is included in the process performed by the control unit 101 of the embodiment. Further, the process performed by confirming means of the invention is included in the process performed by the transmitting/receiving unit 103 of the embodiment.

Next, the technical idea extracted from the embodiment of the information processing device described above will be enumerated as appendices according to the statement form of claims. The technical idea according to the invention can be comprehended by various levels and variations from the generic concept to the subordinate concept, and the invention is not limited to the appendices described below.

What is claimed is:

1. An information processing device for communicating with another information processing devices, the information processing device comprising:
a storage unit for storing a table containing address information which is either permitted or not permitted to notify the another information processing devices;
a processor for performing a process of communicating with the another information processing devices comprising the steps of:
determining whether address information requested from the another information processing device is rated as permitted in the table; and
notifying the requested address information to the another information processing device when the requested address information is rated as permitted in the table.

2. The information processing device according to claim 1, wherein the processor transmits the table to the another information processing device.

3. The information processing device according to claim 1, wherein the processor notifies to the another information processing device whether the requested address is able to noticed or not for confirming to an information processing device identified by the requested address.

4. The information processing device according to claim 1, wherein the table includes a time period in which the requested address can be noticed the another information processing device.

5. The information processing device according to claim 1 further comprising:
display unit for displaying the table, displaying a registration name corresponding to the requested address and not displaying the requested address in the table.

6. The information processing device according to claim 1, wherein the table includes a flag indicative of hide the requested address.

7. The information processing device according to claim 1, wherein the processor sends the requested address to the another information device by attaching the e-mail.

8. The information processing device according to claim 2, wherein the processor transmits the table to the another information apparatus by attaching the e-mail.

9. The information processing device according to claim 1, wherein the requested address is a mail address.

10. The information processing device according to claim 9, wherein the information processing device is a cellular phone.

11. A method for communicating between an information processing device and another information processing device comprising the steps of:
requesting to permit of rating an address information as permitted to notify the another information processing device in a table;
receiving a permit of rating the address information as permitted to notify the another information processing device;
determining whether address information requested from the another information processing device is rated as permitted in the table containing an address which is either permitted or not permitted to notify the another information processing device; and
notifying the requested address to the another information processing device when determining the requested address information is rated as permitted in the table.

12. An information processing device for communicating with another information processing devices comprising:
a processor for performing a process of communicating with the another information processing apparatus comprising the steps of:
determining whether a requested address is registered or not in a table recording an address which is permitted to notify outside the information processing device, the requested address being requested from the another information processing device; and
notifying the requested address to the another information processing device when the requested address is registered in the table.
